(19) United States
(12) Patent Application Publication
(10) Pub. No.: US 2015/0046850 A1
(43) Pub. Date: Feb. 12, 2015

(54) MULTI-DISPLAY SYSTEM

(71) Applicant: Shuichi Kurabayashi, Fujisawa-shi (JP)

(72) Inventor: Shuichi Kurabayashi, Fujisawa-shi (JP)

(21) Appl. No.: 14/357,476

(22) PCT Filed: May 30, 2013
(86) PCT No.: PCT/US13/43293

§ 371 Date: May 9, 2014

(51) Int. Cl. G06F 3/14; G06F 17/22; G09G 5/12

(52) U.S. Cl. CPC G06F 3/1423; G09G 5/12; G06F 17/2247
USPC 715/761; 345/1.3

(57) ABSTRACT

A method performed under control of a system may include extracting a plurality of subtrees from a data structure constituting an application and assigning the subtrees to a plurality of displays.

### BACKGROUND

Two or more display devices may be connected with a single computer and operate to produce a single large display. Such a multi-display facility is needed in various fields such as traffic control operations, finance control operations or a medical field where large volumes of information are handled at the same time. Showing multiple pieces of information simultaneously allows an improved operating efficiency and faster decision making

### SUMMARY

In an example, a method performed under control of a system may include extracting a plurality of subtrees from a data structure constituting an application, and assigning the subtrees to a plurality of displays.

In another example, a system may include an extracting unit configured to extract a plurality of subtrees from a data structure constituting an application, and an assigning unit configured to assign the subtrees to a plurality of displays.

In yet another example, a computer-readable storage medium may store thereon computer-executable instructions that, in response to execution, cause a system to perform operations including extracting a plurality of subtrees from a data structure constituting an application, and assigning the subtrees to a plurality of displays.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. With the understanding that these drawings depict only several embodiments in accordance with the disclosure and are, therefore, not to be considered limiting of its scope, the disclosure will be described with additional specificity and detail through use of the accompanying drawings, in which:

FIG. 1 schematically show an illustrative example of a multi-display system, arranged in accordance with at least some embodiments described herein;

FIG. 2 shows an illustrative example of multiple display devices, arranged in accordance with at least some embodiments described herein;

FIG. 3 shows a schematic block diagram illustrating an example architecture for an apparatus, arranged in accordance with at least some embodiments described herein;

FIG. 4 shows another schematic block diagram illustrating an example architecture for an apparatus, arranged in accordance with at least some embodiments described herein;

FIG. 5 shows schematic block diagram illustrating an example architecture for a subtree control manager of FIG. 4, arranged in accordance with at least some embodiments described herein;

FIG. 6 shows an example flow diagram of a process for assigning subtrees to multiple display devices, arranged in accordance with at least some embodiments described herein;

FIG. 7 illustrates computer program products that may be utilized to provide a scheme for assigning subtrees to multiple display devices, arranged in accordance with at least some embodiments described herein; and

FIG. 8 is a block diagram illustrating an example computing device that may be utilized to provide a scheme for assigning subtrees to multiple display devices, arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatuses, systems, devices, and computer program products related to a multi-display system. Technologies are generally described for an apparatus that extracts multiple subtrees from a data structure constituting an application and assigns the extracted multiple subtrees to multiple display devices.

In some examples, an apparatus may be connected to multiple display devices with an electric wire. Alternatively, the apparatus may be connected to the multiple display devices via a wired or wireless network. By way of example, but not limited to, the apparatus may include a desk top computer, a notebook computer, a laptop computer, a node of a cloud system, etc and each of the multiple display devices may include a monitor, a television, a mobile device that includes a display screen, etc.

An application may be activated/operated on the apparatus. The application may be comprised of multiple user interface (UI) components. By way of example, but not limited to, the application may be constituted by a data structure which includes multiple Hypertext Mark-up Language (HTML) tags or Cascading Style Sheets (CSS) tags. The data structure may be a document object model (DOM). The document object model (DOM) is a cross-platform and language-independent convention for representing and interacting with objects in HTML, XHTML, XML, and CSS documents. The apparatus may execute the application by reading and executing the HTML tags or the CSS tags according to the document object model (DOM).

The data structure which constitutes the application may include multiple subtrees. Each of the multiple user interface components of the application may be constituted by each subtree of the data structure. The apparatus may extract each of the multiple subtrees from the data structure. Then, the apparatus may assign each of the extracted subtrees to each of multiple display devices according to usages of the respective multiple display devices. By way of example, but not limited to, the apparatus may assign, to a first display device (e.g., a television), a first subtree constituting a first user interface component (e.g., a main content part of a web page). Further, the apparatus may assign, to a second display device (e.g., a mobile device), a second subtree constituting a second user interface component (e.g., a menu part of the web page). Accordingly, each of the multiple user interface components constituting the single application may be distributed to the multiple display devices based on the usages of the multiple display devices. Then, each of the multiple user interface components may be displayed on each of the multiple display devices.

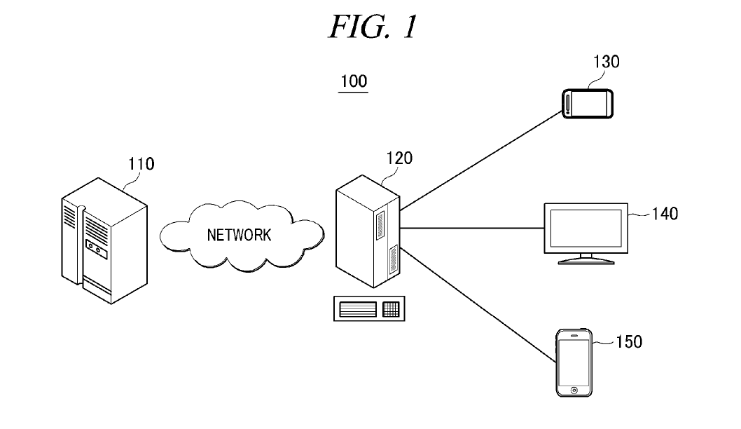

FIG. 1 schematically show an illustrative example of a multi-display system 100 including a web server 110, an apparatus 120, a first display device 130, a second display device 140 and a third display device 150, arranged in accordance with at least some embodiments described herein. Web server 110 may refer to either hardware (e.g., a computer or a server) or software (e.g., an application) that helps to deliver web content that can be accessed through a wired or a wireless network such as the Internet.

Apparatus 120 may be a server, a system, a device, a node of a cloud system, etc that may be capable of executing and operating an application which is provided from web server 110 via a network. By way of example, but not limited to, apparatus 120 may include a laptop computer, a desk top computer, a notebook computer, a mobile device, a personal communication terminal, such as PCS (Personal Communication System), GMS (Global System for Mobile communications), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access) and Wibro (Wireless Broadband Internet) terminals.

By way of example, but not limited to, the network between web server 110 and apparatus 120 may include a wired network such as LAN (Local Area Network), WAN (Wide Area Network), VAN (Value Added Network) or the like, or all kinds of wireless network such as a mobile radio communication network, a satellite network, a bluetooth, WiBro (Wireless Broadband Internet), Mobile WiMAX, HSDPA (High Speed Downlink Packet Access) or the like.

Each of first display device 130, second display device 140 and third display device 150 may be connected to apparatus 120 via an electric wire, a wireless network or a wired network. First display device 130, second display device 140 and third display device 150 may refer to all kinds of display device that has a screen capable of displaying an image or a video. By way of example, but not limited to, first display device 130, second display device 140 and third display device 150 may respectively include a computer monitor, a notebook computer, a mobile device, a portable display device, a television, etc. Although FIG. 1 illustrates that three display devices (i.e., first display device 130, second display device 140, third display device 150) are connected to apparatus 120, one skilled in the art will appreciate that any number of display devices can be connected to apparatus 120.

In some embodiments, apparatus 120 may execute an application which is provided from web server 110 via the network. The application may be constituted by a data structure which includes multiple data subtrees. The multiple data subtrees may include Hypertext Mark-up Language (HTML) tags or Cascading Style Sheets (CSS) tags. By way of example, the data structure that constitutes the application may refer to a document object model (DOM). The hypertext mark-up language tags or the cascading style sheets tags that constitute the application may include at least one javascript program, so the application may be controlled by executing the at least one javascript program.

Although, it is described that the application is provided from web server 110 to apparatus 120, the application may include all kinds of applications executable by apparatus 120 without an intervention of web server 110.

The application may include multiple user interface components. Further, each of the multiple user interface components of the application may be constituted by a subtree included in the data structure. That is, each subtree of the data structure constituting the application may correspond to each of the multiple user interface components of the application.

In some embodiments, apparatus 120 may extract multiple subtrees from the data structure constituting the application. By way of example, but not limited to, apparatus 120 may extract multiple subtrees from the data structure by a single tag unit based on the hypertext mark-up language tag or the cascading style sheets tag.

In some embodiments, apparatus 120 may extract multiple subtrees from the data structure based on the number of display devices. By way of example, in FIG. 1, three display devices of first device 130, second display device 140 and third display device 150 are connected to apparatus 120, so apparatus 120 may divide the data structure constituting the application into three subtrees and extract the three subtrees. Alternatively, the number of extracted subtrees may be larger than the number of display devices connected to apparatus 120.

Apparatus 120 may assign the extracted subtrees to the multiple display devices. In some embodiments, apparatus 120 may assign each of the extracted subtrees to first display device 130, second display device 140 and third display device 150 according to usages of each of first display device 130, second display device 140 and third display device 150. By way of example, but not limited to, apparatus 120 may identify a content of each user interface component which corresponds to each of the extracted subtrees. Then, apparatus 120 may determine whether each user interface component corresponds to the usages of each of first display device 130, second display device 140 and third display device 150 based on the identified contents of each user interface component and also based on at least one of a size, type, or performance of first display device 130, second display device 140 and third display device 150.

Accordingly, apparatus 120 may assign each of the extracted subtrees to first display device 130, second display device 140 and third display device 150 based on the usages of display devices and the contents of each user interface component which corresponds to each of the extracted subtrees. Further, since apparatus 120 corresponds (i.e., extracts and assigns) a subtree to a display device, full contents of each user interface component may be displayed on a single display device (i.e., first display device 130, second display device 140 or third display device 150), while each user interface component is not divided into two or more parts.

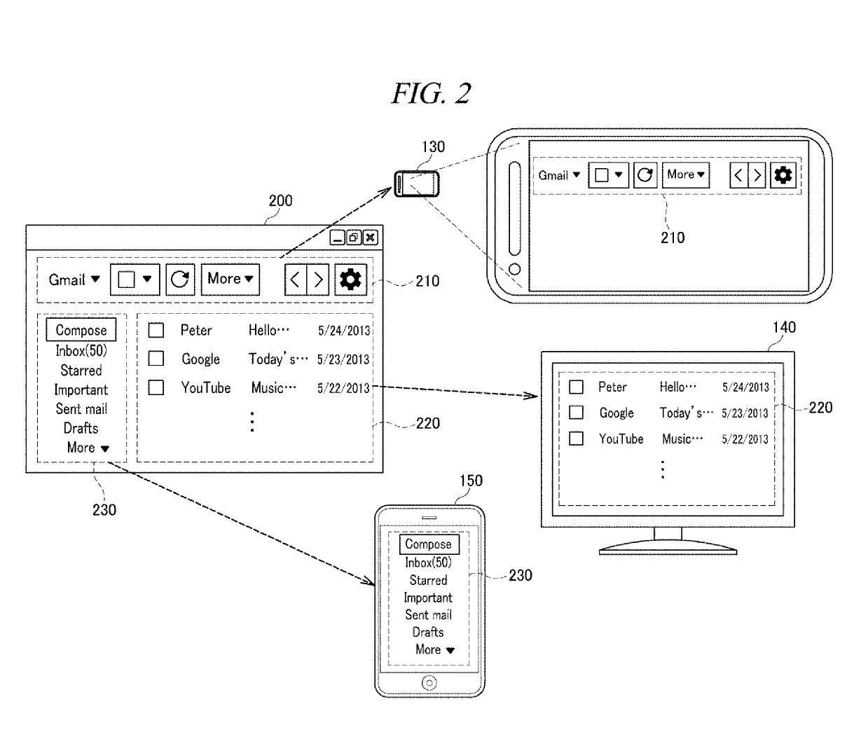

FIG. 2 shows an illustrative example of multiple display devices, arranged in accordance with at least some embodiments described herein. An application 200 may include a first user interface component 210, a second user interface component 220 and a third user interface component 230. By way of example, it may be assumed that application 200 is a web page (e.g., e-mail web page) provided by web server 110 illustrated in FIG. 1. Further, it may be assumed that first user interface component 210 is a top menu part, second user interface component 220 is a main contents part of the web page and third user interface component 230 is an e-mail menu part of the web page.

Further, in FIG. 2, it may be assumed that first display device 130 is a small sized mobile device, second display device 140 is a computer monitor and third display device 150 is a tablet personal computer.

In some embodiments, apparatus 120 may extract three subtrees from a data structure that constitutes application 200. By way of example, but not limited to, apparatus 120 may extract a first subtree from the data structure based on a first hypertext mark-up language tag that constitutes first user interface component 210 (i.e., “the top menu part”). Further, apparatus 120 may extract a second subtree from the data structure based on a second hypertext mark-up language tag that constitutes second user interface component 220 (i.e., “the main contents part of the e-mail web page”). Further, apparatus 120 may extract a third subtree from the data structure based on a third hypertext mark-up language tag that constitutes third user interface component 230 (i.e., “the e-mail menu part of the e-mail web page”).

In some embodiments, apparatus 120 may assign the extracted three subtrees to first display device 130, second display device 140 and third display device 150, respectively, according to at least one of usages of each display device and contents of each user interface component (i.e., first user interface component 210, second user interface component 220, third user interface component 230).

By way of example, but not limited to, apparatus 120 may match the contents of each user interface component and the usages of each display device. Upon matching, apparatus 120 may determine that the content of first user interface component 210 (i.e., “the top menu part”) corresponds to the usage of first display device 130 (i.e., “small sized mobile device”) because the content of first user interface component 210 requires a relatively small size screen. Further, apparatus 120 may determine that the content of second user interface component 220 (i.e., “the main contents part of the e-mail web page”) corresponds to the usage of second display device 140 (i.e., “computer monitor”) because the content of second user interface component 220 requires a relatively large size screen. Further, apparatus 120 may determine that the content of third user interface component 230 (i.e., “the e-mail menu part of the e-mail web page”) corresponds to the usage of third display device 150 (i.e., “tablet personal computer”) because the content of third user interface component 230 requires a relatively middle size screen.

Then, first user interface 210 which is constituted by the first subtree may be displayed on first display device 130. By way of example, first user interface 210 may be displayed on a web browser installed in first display device 130. Further, second user interface 220 which is constituted by the second subtree may be displayed on second display device 140. By way of example, second user interface 220 may be displayed on a web browser installed in second display device 140. Further, third user interface 230 which is constituted by the third subtree may be displayed on third display device 150. By way of example, third user interface 230 may be displayed on a web browser installed in third display device 150.

Further, since apparatus 120 may extract and assign a subtree by a single tag unit based on the hypertext mark-up language tag, full contents of each user interface component may be displayed on a single display device, while each user interface component is not divided into two or more parts. By way of example, but not limited to, as depicted in FIG. 2, second display device 140 does not display a part of second user interface 220 (i.e., “the main contents part of the e-mail web page”), but full content of second user interface 220 may be displayed on second display device 140.

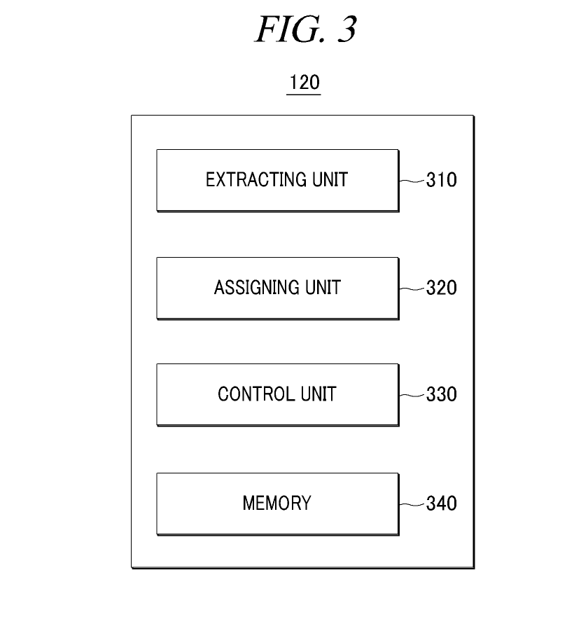

FIG. 3 shows a schematic block diagram illustrating an example architecture for an apparatus 120, arranged in accordance with at least some embodiments described herein. As depicted in FIG. 3, apparatus 120 may include an extracting unit 310, an assigning unit 320, a control unit 330 and a memory 340. Although illustrated as discrete components, various components may be divided into additional components, combined into fewer components, or eliminated altogether while being contemplated within the scope of the disclosed subject matter. It will be understood by those skilled in the art that each function and/or operation of the components may be implemented, individually and/or collectively, by a wide range of hardware, software, firmware, or virtually any combination thereof. In that regard, one or more of extracting unit 310, assigning unit 320, control unit 330 and memory 340 may be included in an instance of an application hosted on apparatus 120.

Extracting unit 310 may be configured to extract multiple subtrees from a data structure that constitutes an application. Each of the multiple subtrees may constitute each of multiple user interface components included in the application. By way of example, but not limited to, the data structure that constitutes the application may be a document object model (DOM). In some embodiments, each of the multiple subtrees may include at least one Hypertext Mark-up Language (HTML) tag or at least one Cascading Style Sheets (CSS) tag. The hypertext mark-up language tags or the cascading style sheets tags that constitutes the application may include at least one javascript program.

In some embodiments, extracting unit 310 may be configured to extract each of the multiple subtrees according to each of the hypertext mark-up language tag or the cascading style sheets tag. Accordingly, extracting unit 310 may extract the multiple subtrees by a single tag unit.

Further, extracting unit 310 may be configured to extract the multiple subtrees based on the number of multiple display devices which are connected to apparatus 120. The number of the extracted multiple subtrees may be associated with the number of the multiple display devices. In some embodiments, the number of the extracted multiple subtrees may be equal to or larger than the number of the multiple display devices.

Assigning unit 320 may be configured to assign the extracted multiple subtrees to the multiple display devices according to usages of the multiple display devices. Further, assigning unit 320 may be configured to assign the extracted multiple subtrees to the multiple display devices based on a content of each user interface component to which each of the subtrees corresponds.

In some embodiments, assigning unit 320 may be configured to identify the content of each user interface component to which each of the subtrees corresponds. Further, assigning unit 320 may be configured to match each of the user interface component and each of the multiple display devices based on the identified contents of the each user interface component and the usages of the each multiple display device. Then, assigning unit 320 may be configured to assign a subtree from among the extracted multiple subtrees to a display device based on the matching result.

Control unit 330 may be configured to control and operate the application by controlling the at least one javascript program which is included in the hypertext mark-up language tag or the cascading style sheets tag that constitutes the application.

Further, control unit 330 may be configured to receive an event which is generated by a user with regard to the each user interface component. By way of example, but not limited to, the event may include a mouse click or a keyboard input to the each user interface component included in the application. Control unit 330 may be configured to respond to the event and make a change into the contents of each the user interface component based on the javascript programs.

Memory 340 may be configured to store various parameters and data which may be used by control unit 330 when control unit 330 executes the javascript programs.

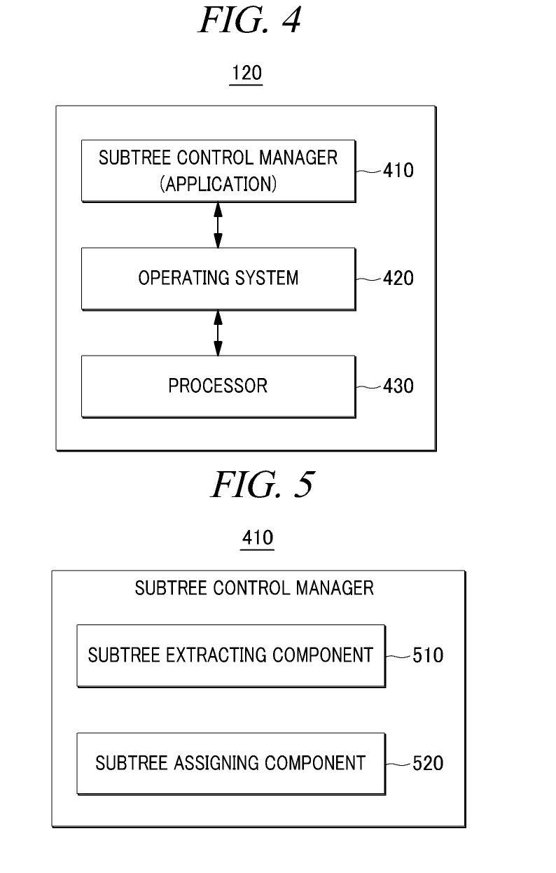

FIG. 4 shows another schematic block diagram illustrating an example architecture for an apparatus 120, arranged in accordance with at least some embodiments described herein. As depicted, apparatus 120 may include a subtree control manager 410, an operating system 420 and a processor 430. Subtree control manager 410 may be an application adapted to operate on operating system 420 such that schemes for extracting multiple subtrees from a data structure constituting an application and assigning the extracted multiple subtrees to multiple display devices as described herein may be provided. Operating system 420 may allow subtree control manager 410 to manipulate processor 430 to implement the schemes for extracting multiple subtrees from a data structure constituting an application and assigning the extracted multiple subtrees to multiple display devices as described herein.

FIG. 5 shows schematic block diagram illustrating an example architecture for a subtree control manager 410 of FIG. 4, arranged in accordance with at least some embodiments described herein. As depicted, subtree control manager 410 may include a subtree extracting component 510 and a subtree assigning component 520.

Subtree extracting component 510 may be configured to extract multiple subtrees from a data structure that constitutes an application. In some embodiments, each of the multiple subtrees may include at least one Hypertext Mark-up Language (HTML) tag or at least one Cascading Style Sheets (CSS) tag. Each of the multiple subtrees may constitute each of multiple user interface components included in the application. Subtree extracting component 510 may be configured to extract each of the multiple subtrees according to each of the hypertext mark-up language tag or the cascading style sheets tag. Accordingly, subtree extracting component 510 may extract the multiple subtrees by a single tag unit.

Further, subtree extracting component 510 may be configured to extract the multiple subtrees based on the number of multiple display devices which arc connected to apparatus 120. The number of the extracted multiple subtrees may be associated with the number of the multiple display devices. In some embodiments, the number of the extracted multiple subtrees may be equal to or larger than the number of the multiple display devices.

Subtree assigning component 520 may be configured to assign the extracted multiple subtrees to the multiple display devices according to usages of the multiple display devices. Further, subtree assigning component 520 may be configured to assign the extracted multiple subtrees to the multiple display devices based on a content of the each user interface component to which each of the subtrees corresponds.

In some embodiments, subtree assigning component 520 may be configured to identify the content of the each user interface component to which each of the subtrees corresponds. Further, subtree assigning component 520 may be configured to match the each user interface component and each of the multiple display devices based on the identified contents of the each user interface component and the usages of the each multiple display device. Then, subtree assigning component 520 may be configured to assign a subtree from among the extracted multiple subtrees to a display device based on the matching result.

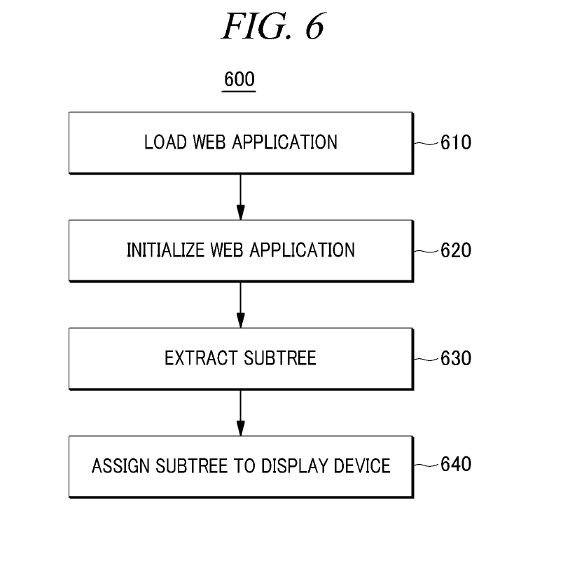

FIG. 6 shows an example flow diagram of a process 600 of an apparatus 120 for assigning subtrees to multiple display devices, arranged in accordance with at least some embodiments described herein. The method in FIG. 6 may be implemented in multi-display system 100 including web server 110, apparatus 120, first display device 130, second display device 140 and third display device 150, as illustrated in FIG. 1. An example process may include one or more operations, actions, or functions as illustrated by one or more blocks 610, 620, 630 and/or 640. Although illustrated as discrete blocks, various blocks may be divided into additional blocks, combined into fewer blocks, or eliminated, depending on the desired implementation. Processing may begin at block 610.

At block 610 (Load Web Application), apparatus 120 may receive an application file from web server 110. By way of example, but not limited to, the application file may include javascript programs and at least one of multiple hypertext mark-up language tags or multiple cascading style sheets tags that constitute a web application. Apparatus 120 may read the hypertext mark-up language tags, the cascading style sheets tags and the javascript programs, so that the web application may be loaded. Although, at block 610, apparatus 120 receives the application file to load the web application from web server 110, an application which is executable without an intervention of web server 110 may be loaded by apparatus 120. Processing may proceed from block 610 to block 620.

At block 620 (Initialize Web Application), apparatus 120 may execute the read javascript programs to initialize the web application. The web application may be initialized when the javascript programs are executed and control a document object model of the web application. Processing may proceed from block 620 to block 630.

At block 630 (Extract Subtree), apparatus 120 may extract multiple subtrees from a data structure that constitutes the web application. In some embodiments, each of the multiple subtrees may include the hypertext mark-up language tag or the cascading style sheets tag. Each of the multiple subtrees may constitute each user interface component included in the web application. Apparatus 120 may extract each of the multiple subtrees according to each of the hypertext mark-up language tag or the cascading style sheets tag. Accordingly, apparatus 120 may extract the multiple subtrees by a single tag unit.

Further, at block 630, apparatus 120 may extract the multiple subtrees based on the number of multiple display devices which are connected to apparatus 120. The number of the extracted multiple subtrees may be associated with the number of the multiple display devices. In some embodiments, the number of the extracted multiple subtrees may be equal to or larger than the number of the multiple display devices. Processing may proceed from block 630 to block 640.

At block 640 (Assign Subtree to Display Device), apparatus 120 may assign the extracted multiple subtrees to the multiple display devices according to usages of the multiple display devices. Further, apparatus 120 may assign the extracted multiple subtrees to the multiple display devices based on a content of the each user interface component to which each of the subtrees corresponds.

In some embodiments, at block 640, apparatus 120 may identify the content of the each user interface component to which each of the subtrees corresponds. Further, apparatus 120 may match each of the user interface components and each of the multiple display devices based on the identified contents of the each user interface component and the usages of the each multiple display device. Then, apparatus 120 may assign a subtree from among the extracted multiple subtrees to a display device based on the matching result.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

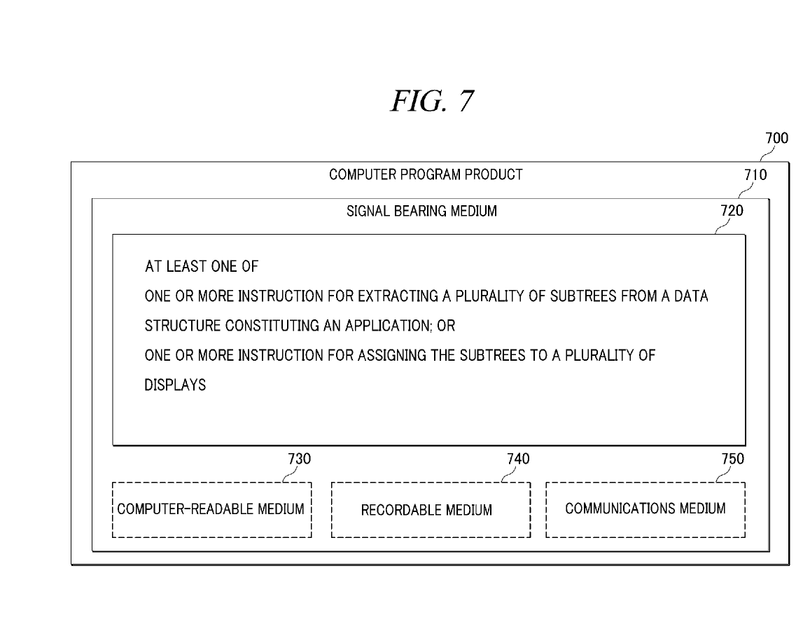

FIG. 7 illustrates computer program products that may be utilized to provide a scheme for assigning subtrees to multiple display devices, arranged in accordance with at least some embodiments described herein. Program product 700 may include a signal bearing medium 710. Signal bearing medium 710 may include one or more instructions 720 that, when executed by, for example, a processor, may provide the functionality described above with respect to FIGS. 1-6. By way of example, but not limitation, instructions 720 may include: one or more instructions for extracting a plurality of subtrees from a data structure constituting an application; and one or more instructions for assigning the subtrees to a plurality of displays. Thus, for example, referring to FIG. 6, apparatus 120 may undertake one or more of the blocks shown in FIG. 6 in response to instructions 720.

In some implementations, signal bearing medium 710 may encompass a computer-readable medium 730, such as, but not limited to, a hard disk drive, a CD, a DVD, a digital tape, memory, etc. In some implementations, signal bearing medium 710 may encompass a recordable medium 740, such as, but not limited to, memory, read/write (R/W) CDs, R/W DVDs, etc. In some implementations, signal bearing medium 710 may encompass a communications medium 750, such as, but not limited to, a digital and/or an analog communication medium (e.g., a fiber optic cable, a waveguide, a wired communications link, a wireless communication link, etc.). Thus, for example, program product 700 may be conveyed to one or more modules of cloud system 120 by an RF signal bearing medium 710, where the signal bearing medium 710 is conveyed by a wireless communications medium 750 (e.g., a wireless communications medium conforming with the IEEE 802.11 standard).

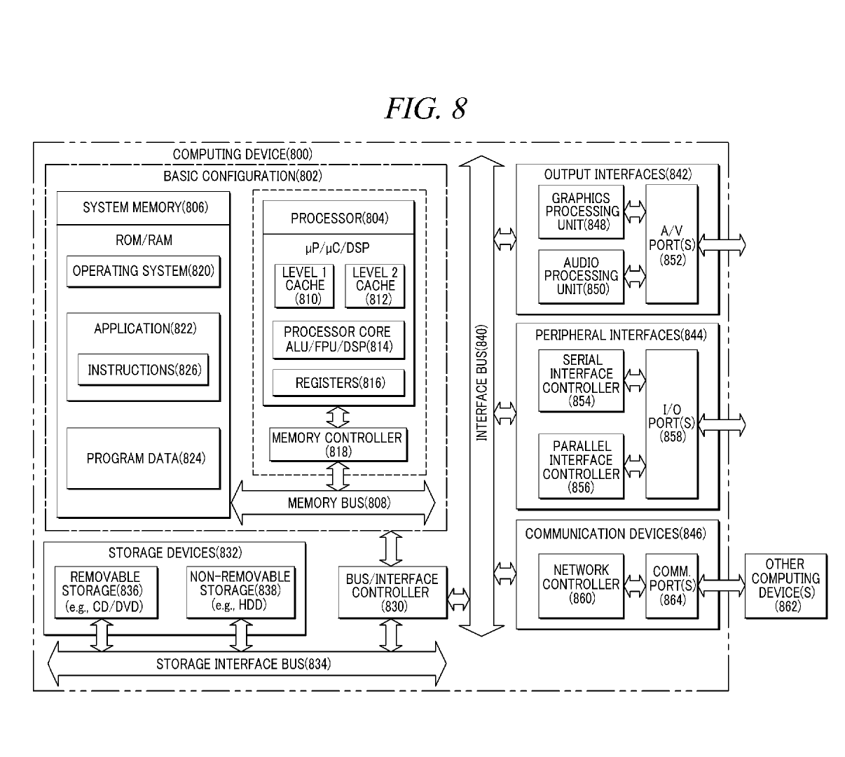

FIG. 8 is a block diagram illustrating an example computing device that may be utilized to provide a scheme for assigning subtrees to multiple display devices, arranged in accordance with at least some embodiments described herein. In these examples, elements of computing device 800 may be arranged or configured for a device. In a very basic configuration 802, computing device 800 typically includes one or more processors 804 and a system memory 806. A memory bus 808 may be used for communicating between processor 804 and system memory 806.

Depending on the desired configuration, processor 804 may be of any type including but not limited to a microprocessor (μP), a microcontroller (μC), a digital signal processor (DSP), or any combination thereof. Processor 804 may include one more levels of caching, such as a level one cache 810 and a level two cache 812, a processor core 814, and registers 816. An example processor core 814 may include an arithmetic logic unit (ALU), a floating point unit (FPU), a digital signal processing core (DSP Core), or any combination thereof. An example memory controller 818 may also be used with processor 804, or in some implementations memory controller 818 may be an internal part of processor 804.

Depending on the desired configuration, system memory 806 may be of any type including but not limited to volatile memory (such as RAM), non-volatile memory (such as ROM, flash memory, etc.) or any combination thereof. System memory 806 may include an operating system 820, an application 822, and program data 824. Application 822 may include instructions 826 that may be arranged to perform the functions as described herein including the actions described with respect to apparatus 120 architecture as shown in FIGS. 3-5 or including the actions described with respect to the flow charts shown in FIG. 6. In some examples, application 822 may be arranged to operate with program data 824 on an operating system 820 such that the schemes for assigning subtrees to multiple display devices as described herein may be provided.

Computing device 800 may have additional features or functionality, and additional interfaces to facilitate communications between basic configuration 802 and any required devices and interfaces. For example, a bus/interface controller 830 may be used to facilitate communications between basic configuration 802 and one or more data storage devices 832 via a storage interface bus 834. Data storage devices 832 may be removable storage devices 836, non-removable storage devices 838, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 806, removable storage devices 836 and non-removable storage devices 838 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 800. Any such computer storage media may be part of computing device 800.

Computing device 800 may also include an interface bus 840 for facilitating communication from various interface devices (e.g., output devices 842, peripheral interfaces 844, and communication devices 846) to basic configuration 802 via bus/interface controller 830. Example output devices 842 include a graphics processing unit 848 and an audio processing unit 850, which may be configured to communicate to various external devices such as a display or speakers via one or more A/V ports 852. Example peripheral interfaces 844 include a serial interface controller 854 or a parallel interface controller 856, which may be configured to communicate with external devices such as input devices (e.g., keyboard, mouse, pen, voice input device, touch input device, etc.) or other peripheral devices (e.g., printer, scanner, etc.) via one or more I/O ports 858. An example communication device 846 includes a network controller 860, which may be arranged to facilitate communications with one or more other computing devices 862 over a network communication link via one or more communication ports 864.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 800 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 800 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method performed under control of a system, comprising:
extracting a plurality of subtrees from a data structure constituting an application; and
assigning the subtrees to a plurality of displays.

2. The method of claim 1, wherein the assigning is based at least in part on usages of each of the displays.

3. The method of claim 2, wherein the application includes a plurality of user interface (UI) components, and
each of the subtrees corresponds to each of the UI components.

4. The method of claim 3, wherein the assigning is performed further based at least in part on a content of the each UI component to which each of the subtrees corresponds.

5. The method of claim 1, wherein a number of the subtrees is associated with a number of the displays.

6. The method of claim 1, wherein the data structure is a document object model (DOM).

7. The method of claim 6, wherein the data structure includes a plurality of Hyper Text Markup Language (HTML) tags, and
the extracting of the subtrees is based at least in part on the tags.

8. The method of claim 7, wherein the application is controlled by a javascript program.

9. The method of claim 1, wherein the system includes at least one of an end device, a computer, a server, or a node of a cloud system.

10. A system, comprising:
an extracting unit configured to extract a plurality of subtrees from a data structure constituting an application; and
an assigning unit configured to assign the subtrees to a plurality of displays.

11. The system of claim 10, wherein the assigning unit assigns the subtrees to the displays based, at least in part, on usages of each of the displays.

12. The system of claim 11, wherein the application includes a plurality of user interface (UI) components, and
each of the subtrees corresponds to each of the UI components.

13. The system of claim 12, wherein the assigning unit assigns the subtrees to the displays further based, at least in part, on a content of the each UI component to which each of the subtrees corresponds.

14. The system of claim 10, wherein a number of the subtrees is associated with a number of the displays.

15. The system of claim 10, wherein the data structure is a document object model (DOM).

16. The system of claim 15, wherein the data structure includes a plurality of Hyper Text Markup Language (HTML) tags, and
the extracting unit extracts the subtrees based, at least in part, on the tags.

17. The system of claim 16, further comprising:
a control unit configured to control the application based at least in part on a javascript program.

18. The system of claim 10, wherein the system includes at least one of an end device, a computer, a server, or a node of a cloud system.

19. A non-transitory computer-readable storage medium having stored thereon computer-executable instructions that, in response to execution, cause a system to perform operations, comprising:
extracting a plurality of subtrees from a data structure constituting an application; and
assigning the subtrees to a plurality of displays.

20. The non-transitory computer-readable storage medium of claim 19, wherein the assigning is based, at least in part, on usages of each of the displays.

21. The non-transitory computer-readable storage medium of claim 19, wherein a number of the subtrees is associated with a number of the displays.
